(19) United States
(12) Patent Application Publication
(10) Pub. No.: US 2020/0004528 A1
(43) Pub. Date: Jan. 2, 2020

(54) FORMALIZED PROPAGATION AND APPROVAL OF CODE CHANGES IN A TIGHTLY COUPLED ENVIRONMENT

(71) Applicant: Microsoft Technology Licensing, LLC, Redmond, WA (US)

(72) Inventors: Nicholas Alexander Pape, Bellevue, WA (US); Peter Blair Gonzalez Del Solar, Mercer Island, WA (US)

(21) Appl. No.: 16/021,806

(22) Filed: Jun. 28, 2018

(51) Int. Cl. G06F 8/71; G06F 8/30; G06F 8/65

(52) U.S. Cl. CPC G06F 8/71; G06F 8/65; G06F 8/30

(57) ABSTRACT

A server determines dependencies of packages in a plurality of repositories. An algorithm calculates a set of compatible versions for the dependencies of the packages, subject to a constraint that no side-by-side versions shall be introduced. A new branch in a repository of the plurality of repositories is created. The package manifests of the new branch are updated based on the set of compatible versions. The files that reference the package manifest in the new branch are updated. The new branch is validated based on the updated files. The server publishes a new version of an updated package in the repository in response to the validation being successful, or automatically determines which parties to notify in response to the validation being unsuccessful.

### TECHNICAL FIELD

The subject matter disclosed herein generally relates to a mechanism that formalizes the sharing relationship between different users and solves the version selection problem for dependency components. Specifically, the present disclosure addresses systems and methods that identify a set of compatible versions, create a new branch in a repository, validate changes in the new branch, publish the updated package to a registry, and propagate updates of the new version throughout a network of repositories.

### BACKGROUND

Repositories store source code files for reusable components that are organized into packages. Updates to those reusable components are tracked with version numbering in a package manifest of a package. The package may depend on one or more other packages. To simplify the description, it will be assumed (without loss of generality) that each repository hosts the source code for a single package. After a new version of a dependency package is published to a registry, a chain of upgrades propagates across multiple repositories. For each package, the software engineers must: upgrade their manifest to the new version of the dependency, build and test the code, increment their own version number, commit this change back to the repository, and then publish a new release to the registry. After all packages in all repositories have been upgraded to use the new version, the propagation is complete. With the increasing number of components and dependencies, both the choreography and inspection of dependency trees has become unmanageable.

### BRIEF DESCRIPTION OF THE DRAWINGS

Some embodiments are illustrated by way of example and not limitation in the figures of the accompanying drawings.

FIG. 1 is a block diagram illustrating an example environment for propagating changes to packages in repositories in accordance with an example embodiment.

FIG. 2 is a block diagram illustrating components within a server in accordance with an example embodiment.

FIG. 3 is a block diagram illustrating components within a propagation application in accordance with an example embodiment.

FIG. 4 is a flow diagram of a method for validating and updating packages in accordance with an example embodiment.

FIG. 5A is a flow diagram of a method for updating a package without introducing side-by-side versions in accordance with an example embodiment.

FIG. 5B is a diagram illustrating example tables of dependencies in accordance with an example embodiment.

FIG. 6 is a block diagram of examples of types of dependencies in accordance with one example embodiment.

FIG. 7 is a diagrammatic representation of a machine in an example form of a computing system within which a set of instructions may be executed for causing the machine to perform any one or more of the methodologies discussed herein, according to an example embodiment.

FIGS. 8A, 8B, 8C are diagrams illustrating a pseudocode sample illustrating an example operation of the depth-first searching module according to an example embodiment.

FIG. 9 illustrates an example of a format of a machine-readable changelog file according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Example methods (e.g., algorithms) and systems (e.g., special-purpose machines) are introduced for selecting a compatible set of dependency versions that avoids side-by-side versions and for selectively holding back versions of dependencies. The present disclosure also introduces a machine-readable changelog file format that allows the system to determine which software engineer to notify about the status of the propagation.

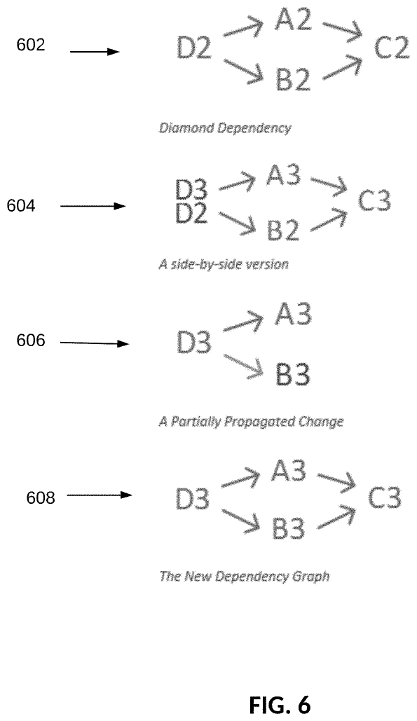

Side-by-side versioning occurs when a package indirectly depends on different versions of a same component. An example of side-by-side versioning is described below with respect to FIG. 6. Side-by-side versioning can be highly problematic. For example, if a software engineer is creating an application that is meant to be used in a web browser. Multiple copies of a dependency increase the number of bytes transmitted via the network resulting in a decrease of the performance of the application. If the dependency is large or if there are many side-by-side versions of it, the performance of the application would considerably degrade. Furthermore, since there are multiple versions of a single package, data structures defined by the different versions of the package may not be interchangeable and build breaks would be difficult to diagnose and fix.

To avoid side-by-side versions, the software engineer would have to inspect the dependency graph and manually select a set of versions that would not cause any side-by-side versions. Additionally, the software engineer has to carefully choreograph the propagation of updates throughout the dependency tree. Both the choreography and inspection of the dependency tree become unmanageable with a sufficiently large dependency graph.

The present disclosure addresses the problem of side-by-side versions by (1) analyzing the dependency graph to select a set of dependency versions for a package that avoids side-by-side versions, (2) creating a new repository branch containing updates to the package manifests of the repositories, (3) building and testing the new repository branch, (4) merging the new repository branch, then triggering packages with dependency updates to be published (effectively solving the choreography problem), (5) generating notifications to corresponding software engineers who may have introduced a breaking change, and (6) selectively holding back certain dependencies on a specific version number, while still including the package in the version selection process.

In accordance with example embodiments, a server determines dependencies of packages in a plurality of repositories. A set of compatible versions for the dependencies of the packages is identified. A new branch in a repository of the plurality of repositories is formed. The package manifest of the new branch is updated based on the set of compatible versions. The files that reference the package manifest in the new branch are updated. The new branch is validated based on the updated files. The server publishes a new version of the updated package to the registry in response to the validation being successful.

One or more of the methodologies described herein facilitate solving the technical problem of side-by-side versioning, wherein multiple versions of a single package coexist. Data structures defined by the different versions of the package may not be interchangeable. This would lead to build breaks that are difficult to diagnose and fix. As such, one or more of the methodologies described herein may obviate a need for certain efforts or computing resources that otherwise would be involved in inspecting dependency graphs of multiple packages and manually selecting a set of versions that would not cause any side-by-side versions in addition to carefully choreographing the propagation of updates throughout the dependency tree.

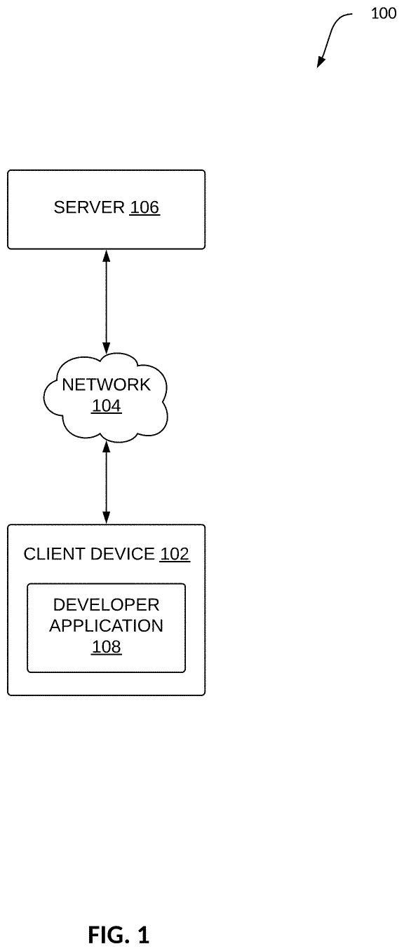

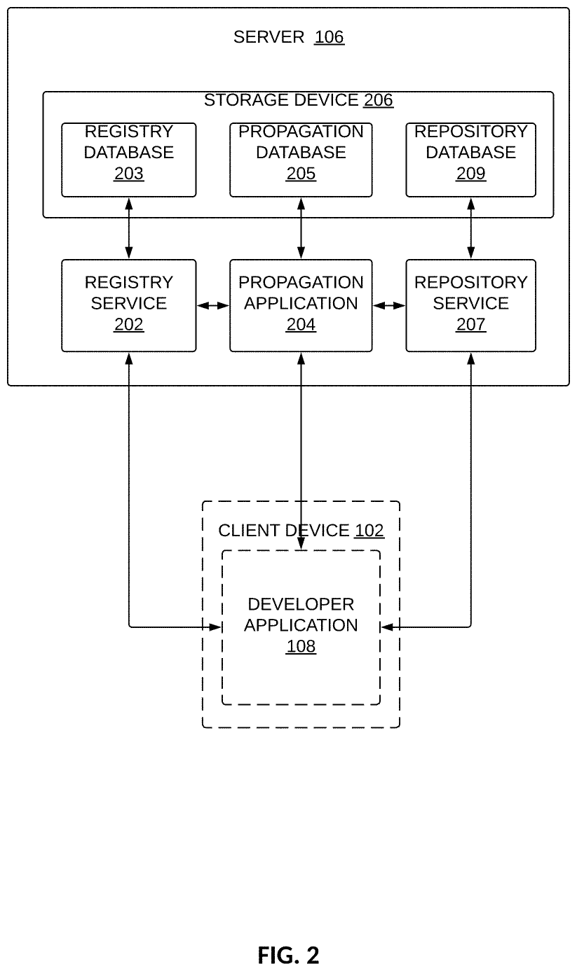

FIG. 1 is a block diagram illustrating an example environment 100 for propagating changes to packages in repositories (without introducing side-by-side versioning) in accordance with an example embodiment. In example embodiments, a server 106 stores and updates versions of packages in repositories. The server 106 will be discussed in more detail in connection with FIG. 2 below.

The server 106 is coupled, via a network 104, to one or more client devices 102. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

The client device 102 includes a developer application 108 configured to communicate files (e.g., send and receive versions of files) or modifications in the files with the server 106. For example, the developer application 108 includes an application for authoring and editing source code, building a package based on the source code, testing the package, and publishing to a package registry at the server 106. In one example embodiment, different tools or servers are involved for each of the previous operations. For example, the registry services, repository services, propagator services can be hosted by three different servers. In another example embodiment, the developer application 108 interacts with the server 106 to perform the different functions previously described.

In one example, the developer application 108 generates an updated version of a package and communicates the updated version of the package to the server 106. In another example, dependencies to the updated version of the package are propagated to other repositories at the server 106.

The client device 102 comprises, but is not limited to, a smartphone, tablet, laptop, multi-processor system, microprocessor-based or programmable consumer electronics system, game console, set-top box, or any other device that a user utilizes to communicate over the network 104. In example embodiments, the client device 102 comprises a display module (not shown) to display information (e.g., in the form of specially configured user interfaces, or in the form of a web browser). In some embodiments, the client device 102 may comprise one or more of a touch screen, camera, keyboard, microphone, and Global Positioning System (GPS) device.

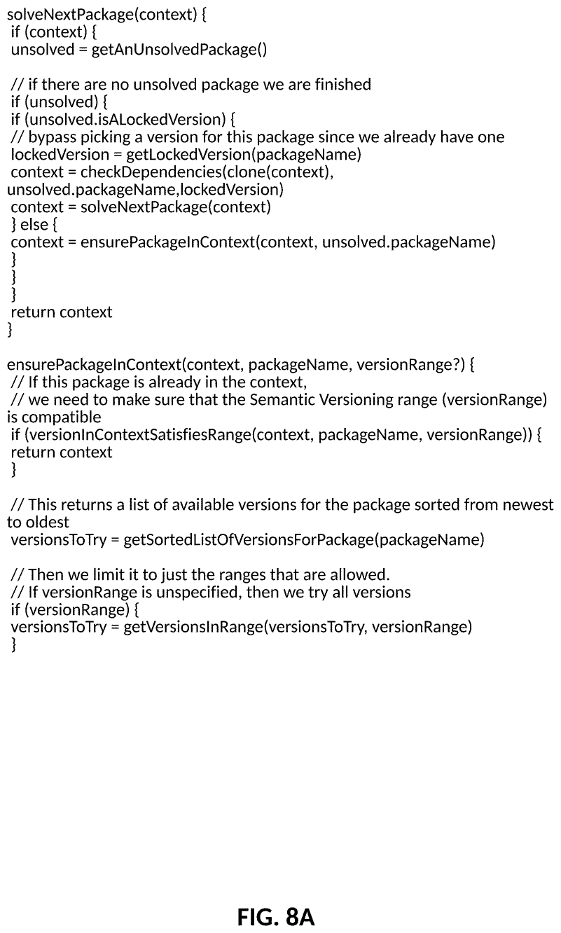

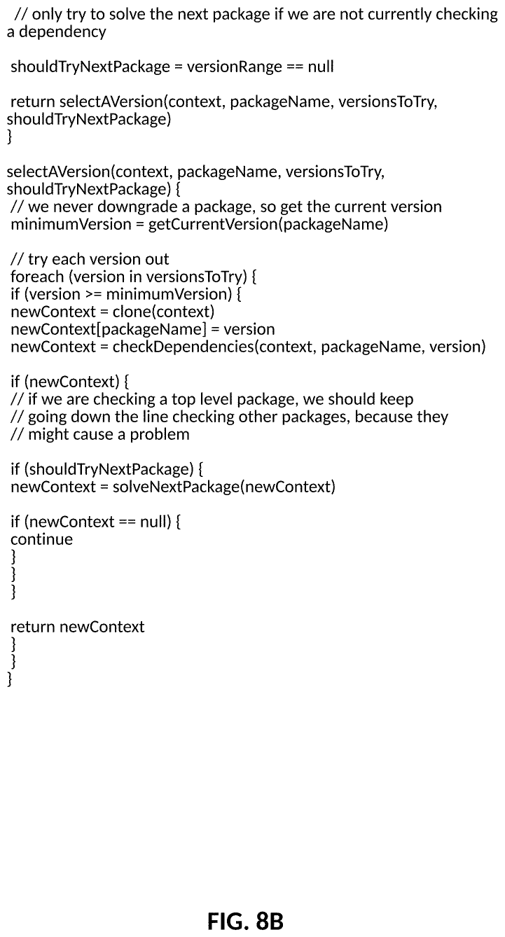

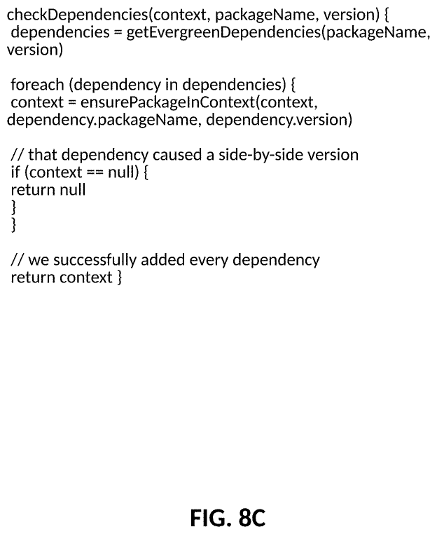

Any of the systems or machines (e.g., databases, devices, or servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 8, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client devices 102 may be embodied within the environment 100. Furthermore, some components or functions of the environment 100 may be combined or located elsewhere in the environment 100. For example, some of the functions of the developer application 108 may be embodied at the server 106.

FIG. 2 is a block diagram illustrating components within the server 106 in accordance with an example embodiment. In example embodiments, the server 106 performs operations to propagate changes to packages in repositories without introducing side-by-side versioning of packages, to generate notifications to corresponding software engineers who have introduced a breaking change, and to selectively hold back dependencies on a specific version number, while still including the package in the version selection process. To enable these operations, the server 106 comprises a registry service 202 that accesses the package binaries in a registry database 203 of a storage device 206, a propagation application 204 that accesses the propagation state and settings in a propagation database 205 of the storage device 206, and a repository service 207 that accesses the package source code in a repository database 209 of the storage device 206, all of which are configured to communicate with each other (e.g., over a bus, shared memory, or a network switch) in accordance with an example embodiment. In one example embodiment, the registry service 202, the repository service 207, and the propagation application 204 may reside on different server machine or on the same server machine as illustrated in FIG. 2.

The registry service 202 is configured to interface and communicate with the developer application 108 at the client device 102. The registry service 202 is a network server application that other users (e.g., software engineers) use to discover and download the package. The registry service 202 receives a copy of a package file from the developer application 108 and stores the package file in the registry database 203 in the storage device 206. In another example, the registry service 202 receives an updated version of the package file from the developer application 108 to replace a former version of the package file with the updated version of the package file.

The repository database 207 stores one or more repositories. Each repository includes a corresponding set of source files for a package and their history over time.

Each repository stores source code for software engineers who collaborate to develop the package. A repository uses a version control system to manage various branches where work is tested before being accepted. Software engineers working in a repository may collaborate on units (e.g., packages). The package is a reusable component that includes a package manifest. The package manifest contains information about the package. After the package source code is built and tested, the package is published to the registry service 202.

A package typically has a dependency on one or many other packages. This means that the package uses assets (e.g., functions) from the dependency package(s). This dependency relationship is recorded in the package manifest. When a software engineer publishes an update to a package, any packages which depend on it could be broken by the change (for example, if an asset was renamed). To address this problem, each release of a package has a unique version number recorded in the package manifest. The package manifest also records the appropriate version numbers for each dependency.

The propagation application 204 determines the version number of each package received from the registry service 202. In one example embodiment, the propagation application 204 analyzes the dependency graph to select a set of dependencies for a package which would result in no side-by-side versions being introduced. In the example embodiment, the propagation application 204 creates a repository branch containing updates to the package manifests, and builds and tests the new branch before merging it to the master branch. The propagation application 204 then triggers packages with dependency updates to be published.

In the example embodiment, the propagation application 204 handles build failures by determining which software engineers may have introduced a breaking change, and communicates reports to them.

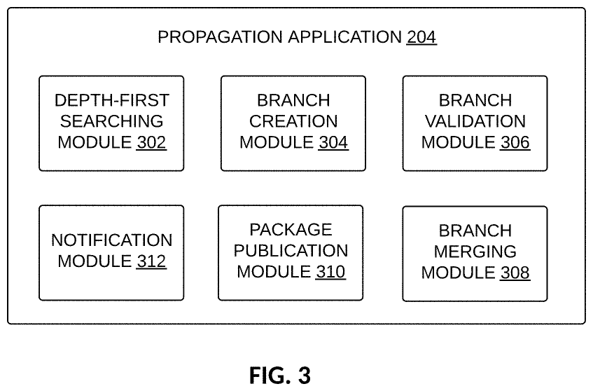

In another example embodiment, the propagation application 204 enables software engineers to selectively hold back certain dependencies on a specific version number, while still including the package in the version selection process. This feature is useful when upgrading a package that is highly disruptive or when a controlled rollout of a selected package is desired. The components and operations of the propagation application 204 are described in more detail below with respect to FIG. 3.

Any one or more of the components (e.g., modules, engines) described herein may be implemented using hardware alone (e.g., one or more processors of a machine) or a combination of hardware and software. For example, any component described herein may physically include an arrangement of one or more of the processors or configure a processor (e.g., among one or more processors of a machine) to perform the operations described herein for that component. Accordingly, different components described herein may include and configure different arrangements of the processors at different points in time or a single arrangement of the processors at different points in time. Each component (e.g., module) described herein is an example of a means for performing the operations described herein for that component. Moreover, any two or more of these components may be combined into a single component, and the functions described herein for a single component may be subdivided among multiple components. Furthermore, according to various example embodiments, components described herein as being implemented within a single machine, database, or device may be distributed across multiple machines, databases, or devices. The server 106 may comprise other components not pertinent to example embodiments that are not shown or discussed. Further still, one or more of the components of the server 106 may be located at one or more of the client devices 102.

FIG. 3 is a block diagram illustrating components within the propagation application 204 in accordance with an example embodiment. The propagation application 204 performs operations to analyzes the dependency graph to select a set of dependencies for a package which would result in no side-by-side versions being introduced and then triggers packages with dependency updates to be published.

To enable these operations, the propagation application 204 comprises a depth-first searching module 302, a branch creation module 304, a branch validation module 306, a notification module 312, a package publication module 310, and a branch merging module 308, all of which are configured to communicate with each other (e.g., by in-process communication, or over a bus, or shared memory, or a switch) in accordance with an example embodiment.

The depth-first searching module 302 includes a version selection algorithm that recursively operates or searches across the registry. At each search stage, the depth-first searching module 302 selects a version of an unsolved package which will not lead to side-by-side versions. The depth-first searching module 302 then repeats itself with the next unsolved package (e.g., by calling the same code again, with a new context). Each of these calls to the same code is commonly referred to as a “frame” and the set of frames is commonly referred to as a “call stack.”

The depth-first searching module 302 starts with the initial context, described above. The depth-first searching module 302 then selects the first unsolved package, for example package “A.” Using a network call to the registry (e.g., registry service 202), the depth-first searching module 302 identifies all available versions for package “A”. The depth-first searching module 302 starts with the newest version number and creates a new stack frame (i.e. a new context) with that version number selected. All the dependencies of package “A” that do not exist in the context are added to the context as “unsolved” dependencies. The depth-first searching module 302 then verifies that side-by-side versions were not introduced.

If no side-by-side version was introduced, the depth-first searching module 302 recursively operates with the next unsolved package. If a side-by-side version is introduced, the depth-first searching module 302 backtracks and tries with the next-newest version number of package “A.” In one example embodiment, the depth-first searching module 302 avoids trying a version of A that would cause A to be downgraded (e.g., the depth-first searching module 302 does not pick a version lower than the version the repository is already using). If all versions of package “A” are attempted, the depth-first searching module 302 would need to backtrack. If the depth-first searching module 302 backtracks to a point where all possible combinations of packages have been tried, there is no valid set of packages. If at any point there are no “unsolved packages”, then the depth-first searching module 302 has successfully selected version numbers and will return the context. In this case the first encountered solution is expected to be very close to optimal; whereas in a different embodiment, the algorithm may continue searching for additional solutions and choose the best solution based on a heuristic ranking criterion such as the largest version increases or the most dependencies upgraded.

In one example embodiment, to verify that no side-by-side versions were introduced, every solved package is iterated in the context. The depth-first searching module 302 then iterates through all the dependencies of each package. If the dependencies of a package are solved in the context, these dependencies are compatible. If they are not, side-by-side versions have been introduced. If the depth-first searching module 302 iterates through all solved packages without finding a side-by-side version, the depth-first searching module 302 determines that no side-by-side versions were introduced. A pseudocode sample illustrating an example operation of the depth-first searching module 302 is shown in FIGS. 8A, 8B, 8C.

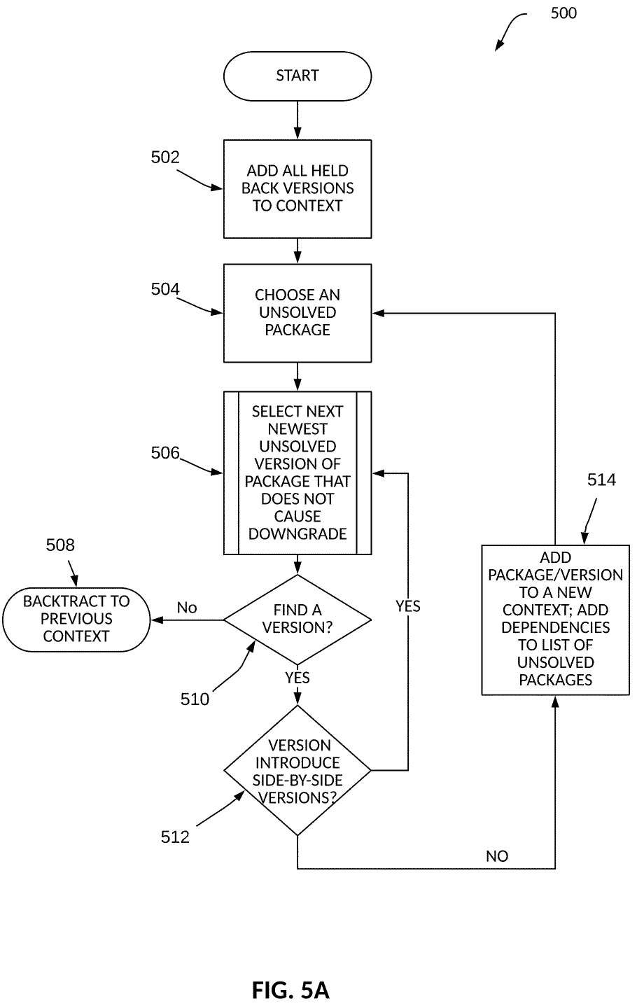

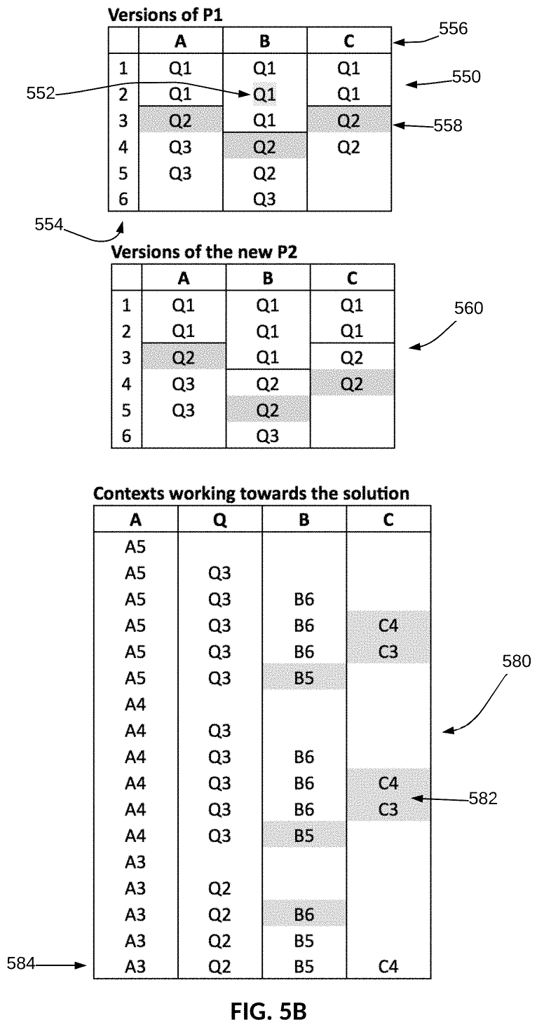

FIG. 5A is a flow diagram illustrating an example operation corresponding to the pseudocode sample of FIGS. 8A, 8B, 8C. In particular, FIG. 5A illustrates a flow diagram of a method for updating a package without introducing side-by-side versions in accordance with an example embodiment. Operations in the method 500 may be performed by the server 106, using components (e.g., modules, engines) described above with respect to FIG. 3. Accordingly, the method 500 is described by way of example with reference to the propagation application 204.

At operation 502, all held back versions are added to a context. A context refers to a data structure representing a mapping of packages to the versions that were selected for them. Some packages may not have selected versions, these are called “unsolved packages.” The “context” initially contains the direct dependencies, which do not have a selected version. If a package is held back by the configuration, then the package is added to the initial context with the specified version number (i.e., it is “pre-solved”).

At operation 504, the propagation application 204 chooses an unsolved package. At operation 506, the propagation application 204 selects the next newest unsolved version of the package that does not cause a downgrade. At operation 510, the propagation application 204 determines whether a new version is found. If a new version is not found, the propagation application 204 backtracks to the previous context. At operation 512, the propagation application 204 determines whether the next newest unsolved version introduces side-by-side versions. If side-by-side versions are introduced, the propagation application 204 selects the next newest unsolved version of the package that does not cause downgrade. If side-by-side versions are introduced, the propagation application 204 adds the unsolved version of the package to the new context and adds dependencies to the list of unsolved packages.

FIG. 5B provides an example of the operations of FIG. 5A: the propagation application 204 processes a package “P” whose direct dependencies are “A”, “B”, and “C”. A, B, and C all depend on an indirect dependency “Q”. FIG. 5B illustrates a table 550 that depicts a version 1 of P (“P1”) presented to the propagation application 204 based on the above assumptions. The row 556 identifies the packages (e.g., A, B, C). The column 554 identifies the version number (e.g., 1, 2, 3, etc.). For example, the cell 552 illustrates that in the starting state of the registry, B2 depends on Q1 (version 1 of Q). The shaded selections 558 show the manifest for version 1 of P. It depends on version 3 of A, version 4 of B, and version 3 of C. For notation purpose, this relationship is written as:
P1=A3/B4/C3. Furthermore, A3 depends on Q2, B3 depends on Q2, and C3 depends on Q2. Thus, Q is an indirect dependency with no side-by-side versions.

In the present example, at the time when P1 was published, the later releases (i.e., A4, A5, B5, B6, and C4) had not been published yet. But now they have. So now, P2 is to be published with upgraded dependencies.

A naive implementation would upgrade the package to use the latest version of all dependencies (e.g., P2=A5/B6/C4). However, this would require side-by-side versions of Q (because A5 depends on Q3 but C4 depends on Q2). The best solution is P2=A3/B5/C4 as depicted in table 560. However, with hundreds of dependencies, it may be difficult to determine the optimal dependencies solution for a package. The present disclosure describes a procedure considering a series of contexts to help solve the best solution.

Table 580 illustrates an example of an operation of determining an optimal dependency solution for a package. Each row is a “context”, which represents a partial solution to the problem. The operation starts optimistically with latest version of everything (A5/B6/C4), and then successively tries downgrading each dependency's version until a compatible set is found. However, the propagation application 204 does not downgrade a version to be earlier than what was started with. For example, the propagation application 204 would not choose A2, or B3, or C2.

The red shaded cells 582 indicate steps where the propagation application 204 detects that side-by-side versions are introduced, and thus backtracks. The final row 584 shows the solution P2=A3/B5/C4 and also Q2. In the future, if someone published a C5 that depends on Q3, then the propagation application 204 could upgrade everything to depend on Q3 without side-by-side versions.

Referring back to FIG. 3, the branch creation module 304 creates a new branch in the repository and updates the package manifest, so that each dependency refers to the version number selected from the set of compatible versions as identified by the depth-first searching module 302.

The branch validation module 306 may execute a program script specified by the repository. This can be used for any special considerations of that repository such as updating files that reference the package manifest. In another example embodiment, the branch validation module 306 performs any build operations, testing, or other operations for validating the branch before merging into the master branch.

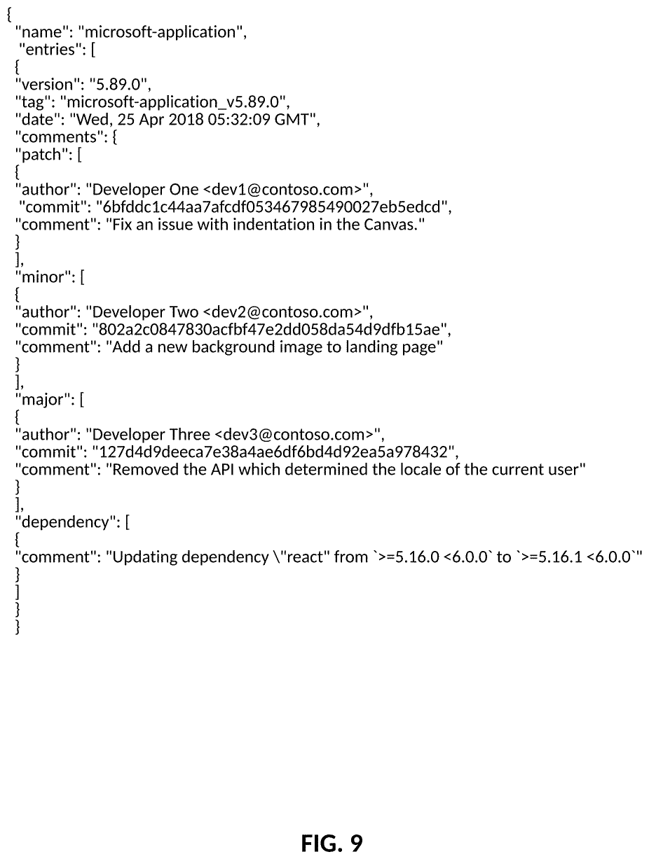

The branch merging module 308 merges the new branch into the master branch of the repository if the branch validation module 306 determines that the validation is successful. Alternatively, if the validation was unsuccessful, the branch merging module 308 invokes the notification module 312 to generate an automated notification (for example email, dashboard notice, or mobile application alert) to the software engineers who made changes in the dependency package as determined by the machine-readable changelog file specified in the present disclosure. An example of a format of a machine-readable changelog file is illustrated in FIG. 9.

The package publication module 310 publishes a new version of the updated package after the new branch has been merged into the master branch.

The notification module 312 generates different types of notifications. For example, the notification module 312 generates a successful merge notification email (to the software engineer corresponding to the package) indicating that the new branch has been successfully merged into the master branch of a repository. In another example, the notification module 312 generates a merge failure notification email (to the software engineer corresponding to the package) indicating that the new branch has not successfully merged into the master branch of a repository. In another embodiment, these notifications may also be provided via an interactive web site or dashboard that allows users to monitor the status of the system and configure various settings.

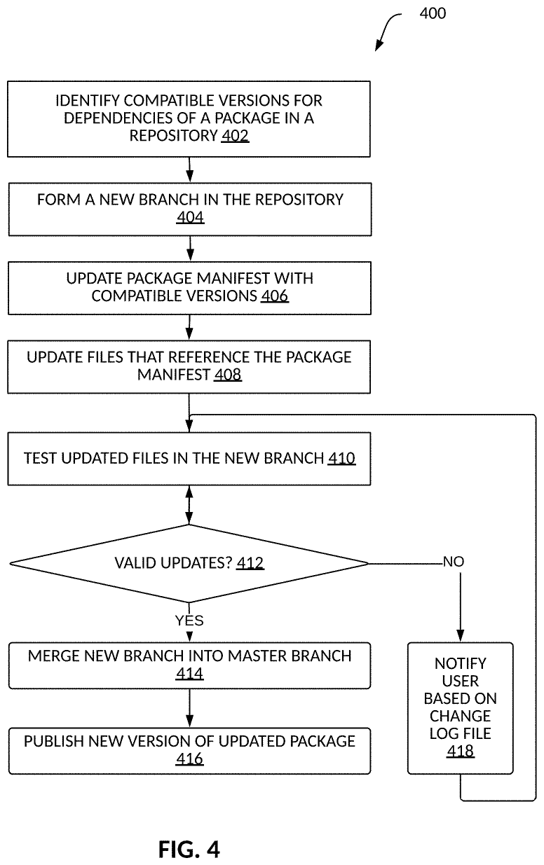

FIG. 4 is a flow diagram of a method 400 for validating and updating packages in accordance with an example embodiment. Operations in the method 400 may be performed by the server 106, using components (e.g., modules, engines) described above with respect to FIGS. 2 and 3. Accordingly, the method 400 is described by way of example with reference to the propagation application 204. However, it shall be appreciated that at least some of the operations of the method 400 may be deployed on various other hardware configurations or be performed by similar components residing elsewhere. For example, some of the operations may be performed at the client device 102.

In operation 402, the propagation application 204 identifies compatible versions for dependencies of a package in a repository at the storage device 206. In example embodiments, operation 402 may be performed with the depth-first searching module 302 to identify the set of compatible versions.

In operation 404, the propagation application 204 creates or forms a new branch in a corresponding repository from the set of compatible versions. In example embodiments, operation 404 may be performed with the branch creation module 304.

In operation 406, the propagation application 204 updates the package manifest of a selected repository with compatible versions. In example embodiments, operation 406 may be performed with the branch creation module 304.

In operation 408, the propagation application 204 executes optional custom scripts that, for example, may update the files that reference the updated package manifest. In example embodiments, operation 408 may be performed with the branch creation module 304.

In operation 410, the propagation application 204 performs operations to test the updated files in the new branch. In example embodiments, operation 410 may be performed with the branch validation module 306.

In operation 412, the propagation application 204 determines whether the updates are valid. In example embodiments, operation 412 may be performed with the branch validation module 306.

In operation 414, if the propagation application 204 determines that the updates are valid, the propagation application 204 merges the new branch into the master branch. In example embodiments, operation 414 may be performed with the branch merging module 308.

In operation 418, if the propagation application 204 determines that the updates are not valid, the propagation application 204 generates a notification to the corresponding user based on the machine-readable changelog file of the package. In example embodiments, operation 418 may be performed with the notification module 312. In one example, the propagation application 204 reads the changelog files for all dependency packages. After operation 418, the propagation application 204 loops back to operation 410.

In operation 416, the propagation application 204 publishes the new version of the updated package. In example embodiments, operation 416 may be performed with the package publication module 310.

FIG. 6 is a block diagram of examples of types of dependencies in accordance with one example embodiment. Side-by-side versions are highly problematic. For example, if a software engineer was creating an application that was meant to be used in a web browser, having multiple copies of a dependency would increase the number of bytes transmitted via the network, which would decrease the performance of the application. If the dependency was very large or if there were many side-by-side versions of it, performance of the application would be considerably degraded. Additionally, since there are multiple versions of a single package, data structures defined by the different versions of the package may not be interchangeable, which would lead to build breaks that are difficult to diagnose and fix.

To avoid side-by-side versions, the software engineer would inspect the dependency graph and manually select a set of versions that would not cause any side-by-side versions to be installed. Additionally, the software engineers would need to carefully choreograph the propagation of updates throughout the dependency tree.

To illustrate this inspection and choreography, a dependency tree 602 shows a diamond dependency in which package C2 (version 2 of package C) directly depends on packages A2 and B2. Both packages A2 and B2 are dependent on package D2. Therefore, package C2 indirectly depends on package D2.

In a dependency tree 604, a new version of package D2 is published as D3. The software engineers working on project A have successfully integrated package D3 and therefore published a new version of project A referred to as A3. However, the software engineers working on project B are unable to integrate D3 for some reason and, therefore, B2 remains dependent on the older version D2. The dependency tree 604 illustrates side-by-side versions where the software engineers working on project C updated to package A3 without considering the dependency graph.

To manually remedy the side-by-side versions, the software engineers working on project C would need to coordinate with the software engineers working on project B to publish package B3 (as illustrated in a dependency tree 606) prior to upgrading to packages B3 and A3 (as illustrated in a dependency tree 608). This choreography and inspection of the dependency tree become unmanageable with large dependency graphs.

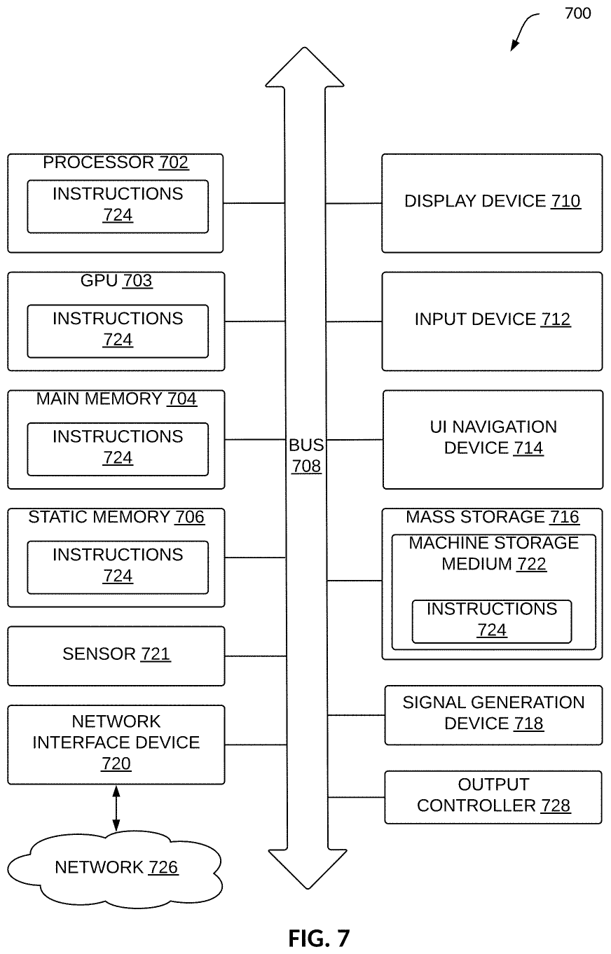

FIG. 7 is a block diagram illustrating components of a machine 700, according to some example embodiments, able to read instructions 724 from a machine-storage medium 722 and perform any one or more of the methodologies discussed herein, in whole or in part. Specifically, FIG. 7 shows the machine 700 in the example form of a computer device (e.g., a computer) within which the instructions 724 (e.g., software, a program, an application, an applet, an app, or other executable code) for causing the machine 700 to perform any one or more of the methodologies discussed herein may be executed, in whole or in part.

For example, the instructions 724 may cause the machine 700 to execute the flows and flow diagrams of FIGS. 4 and 5A. The instructions 724 can transform the general, non-programmed machine 700 into a particular machine (e.g., specially configured machine) programmed to carry out the described and illustrated functions in the manner described.

In alternative embodiments, the machine 700 operates as a standalone device or may be connected (e.g., networked) to other machines. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, a power adapter, or any machine 700 capable of executing the instructions 724, sequentially or otherwise, that specify actions to be taken by that machine 700. Further, while only a single machine 700 is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU) 703, a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a display device 710 (e.g., a plasma display panel (PDP), a light-emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a user interface (UI) navigation device 714 (e.g., a mouse, a touchpad, a trackball, a joystick, a motion sensor, an eye tracking device, or another pointing instrument), a storage unit 716, a signal generation device 718 (e.g., a sound card, an amplifier, a speaker, a headphone jack, or any suitable combination thereof), a network interface device 720, and one or more sensors 721, such as a Global Positioning System (GPS) sensor, compass, accelerometer, or another sensor. The machine 600 may include an output controller 728, such as a serial (e.g., universal serial bus (USB)), parallel, or other wired or wireless (e.g., infrared (IR), near field communication (NFC), etc.) connection to communicate with or control one or more peripheral devices (e.g., a printer, card reader, etc.).

The storage unit 716 includes the machine-storage medium 722 on which are stored the instructions 724 embodying any one or more of the methodologies or functions described herein. The instructions 724 may also reside, completely or at least partially, within the processor 702, the GPU 703, the main memory 704, the static memory 706, or the machine storage medium 722 before or during execution thereof by the machine 700. Accordingly, the main memory 704 and the processor 702 may be considered machine-storage media 722 (e.g., tangible and non-transitory machine-readable media).

In some example embodiments, the machine 700 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a Global Positioning System (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 704, 706, and/or the memory of the processor(s) 702) and/or the storage unit 716 may store one or more sets of instructions 724 and data structures (e.g., software) embodying or utilized by any one or more of the methodologies or functions described herein. These instructions, when executed by the processor(s) 702, cause various operations to implement the disclosed embodiments.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and signal media. Thus, the terms include both storage devices/media and carrier waves/modulated data signals.

The instructions 724 may further be transmitted or received over a communication network 726 using a transmission medium via the network interface device 720 and utilizing any one of a number of well-known transfer protocols (e.g., HTTP). Examples of communication networks 726 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” or “signal medium” shall be taken to include any intangible medium that is capable of storing, encoding, or carrying the instructions 724 for execution by the machine 700, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-storage medium 722 or in a signal medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 702 or a group of processors 702) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application programming interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

### EXAMPLES

Example 1 is a computer-implemented method comprising: determining dependencies of packages in a plurality of repositories, each repository including one or more packages; identifying a set of compatible versions for the dependencies of packages; creating a new branch in a repository of the plurality of repositories; updating a package manifest of the new branch based on the set of compatible versions; updating files that reference the package manifest in the new branch; validating the new branch based on the updated files; and publishing a new version of an updated package in the repository in response to the validating being successful.

Example 2 includes example 1 and further comprises: generating a machine-readable changelog file that identifies an author of changes to a dependency package of the repository.

Example 3 includes example 2 and further comprises: in response to the validating being not successful, generating a notification to the author identified in the machine-readable changelog file.

Example 4 includes example 3 and further comprises: in response to the validating being unsuccessful, preventing the new branch from being merged into a master branch on the repository; and holding back the version of the dependencies of the packages.

Example 5 includes example 3, wherein the notification identifies one or more authors by parsing all changes in all versions between a current version and a newly selected version of the dependency package of the repository.

Example 6 includes example 1, and further comprises: performing a heuristically-directed depth-first search on the plurality of repositories to determine the dependencies of the packages in the plurality of repositories.

Example 7 includes example 1, and further comprises: identifying direct dependencies of packages in the plurality of repositories.

Example 8 includes example 1, and further comprises: in response to the validating being successful, merging the new branch into a master branch in the repository.

Example 9 includes example 1, and further comprises: recursively determining the dependencies of the packages in the plurality of repositories after publishing the new version of the updated package.

Example 10 includes example 7, wherein the set of compatible versions for the dependencies of the packages excludes side-by-side version dependencies.

Although an overview of the present subject matter has been described with reference to specific example embodiments, various modifications and changes may be made to these embodiments without departing from the broader scope of embodiments of the present disclosure. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A computer-implemented method comprising:
determining dependencies of packages in a plurality of repositories, each repository including one or more packages;
identifying a set of compatible versions for the dependencies of the packages;
creating a new branch in a repository of the plurality of repositories;
updating a package manifest of the new branch based on the set of compatible versions;
updating files that reference the package manifest in the new branch;
validating the new branch based on the updated files;
publishing a new version of an updated package in the repository in response to the validating being successful;
generating a machine-readable changelog file that identifies an author of changes to a dependency package of the repository; and
in response to the validating being successful, generating a notification to the author identified in the machine-readable changelog file, the notification indicating that the new branch has been successfully merged into a master branch in the repository.

2. (canceled)

3. (canceled)

4. (canceled)

5. The computer-implemented method of claim 1, wherein the notification identifies one or more authors by parsing all changes in all versions between a current version and a newly selected version of the dependency package of the repository.

6. The computer-implemented method of claim 1, further comprising:
performing a heuristically-directed depth-first search on the plurality of repositories to determine the dependencies of the packages in the plurality of repositories.

7. The computer-implemented method of claim 1, further comprising:
identifying direct dependencies of the packages in the plurality of repositories.

8. The computer-implemented method of claim 1, further comprising:
in response to the validating being successful, merging the new branch into a master branch in the repository.

9. The computer-implemented method of claim 1, further comprising:
recursively determining the dependencies of the packages in the plurality of repositories after publishing the new version of the updated package.

10. The computer-implemented method of claim 1, wherein the set of compatible versions for the dependencies of the packages excludes side-by-side version dependencies.

11. A system comprising:
one or more hardware processors; and
a memory storing instructions that, when executed by the one or more hardware processors, cause the one or more hardware processors to perform operations comprising:
determining dependencies of packages in a plurality of repositories, each repository including one or more packages;
identifying a set of compatible versions for the dependencies of the packages;
creating a new branch in a repository of the plurality of repositories;
updating a package manifest of the new branch based on the set of compatible versions;
updating files that reference the package manifest in the new branch;
validating the new branch based on the updated files;
publishing a new version of an updated package in the repository in response to the validating being successful;
generating a machine-readable changelog file that identifies an author of changes to a dependency package of the repository; and
in response to the validating being successful, generating a notification to the author identified in the machine-readable changelog file, the notification indicating that the new branch has been successfully merged into a master branch in the repository.

12. (canceled)

13. (canceled)

14. (canceled)

15. The system of claim 11, wherein the notification identifies one or more authors by parsing all changes in all versions between a current version and a newly selected version of the dependency package of the repository.

16. The system of claim 11, wherein the operations further comprise:
performing a heuristically-directed depth-first search on the plurality of repositories to determine the dependencies of the packages in the plurality of repositories.

17. The system of claim 11, wherein the operations further comprise:
identifying direct dependencies of the packages in the plurality of repositories.

18. The system of claim 11, wherein the operations further comprise:
in response to the validating being successful, merging the new branch into a master branch in the repository.

19. The system of claim 11, wherein the operations further comprise:
recursively determining the dependencies of the packages in the plurality of repositories after publishing the new version of the updated package.

20. A machine-storage medium storing instructions that, when executed by one or more processors of a machine, cause the one or more processors to perform operations comprising:
determining dependencies of packages in a plurality of repositories, each repository including one or more packages;
identifying a set of compatible versions for the dependencies of the packages;
creating a new branch in a repository of the plurality of repositories;
updating a package manifest of the new branch based on the set of compatible versions;
updating files that reference the package manifest in the new branch;
validating the new branch based on the updated files;
publishing a new version of an updated package in the repository in response to the validating being successful;
generating a machine-readable changelog file that identifies an author of changes to a dependency package of the repository; and
in response to the validating being successful, generating a notification to the author identified in the machine-readable changelog file, the notification indicating that the new branch has been successfully merged into a master branch in the repository.
